(19) United States
(12) Patent Application Publication
(10) Pub. No.: US 2007/0100592 A1
(43) Pub. Date: May 3, 2007

(54) Virtual sampling system

(75) Inventors: Ronald D. Lish, Beaverton, OR (US); Michael L. Marchione, Lake Oswego, OR (US)

Correspondence Address: BANNER & WITCOFF, LTD., TEN SOUTH WACKER DRIVE, SUITE 3000, CHICAGO, IL, 60606, US

(73) Assignee: Nike, Inc., Beaverton, OR (US)

(21) Appl. No.: 11/261,112

(22) Filed: Oct. 28, 2005

(51) Int. Cl. G06G 7/48

(52) U.S. Cl. 703/6

(57) ABSTRACT

Virtual sampling systems and methods are disclosed. Images of footwear are masked into distinct sections. Images of a variety of materials and textures and color data are stored in libraries. A computer device is configured to retrieve material and texture images and color data from the libraries and apply them to an image of footwear to create a virtual design of an article of footwear.

### FIELD OF THE INVENTION

The invention relates to systems used to design footwear. More particularly, the invention provides methods and systems for creating virtual representations of footwear utilizing design element images obtained from libraries.

### BACKGROUND OF THE INVENTION

Conventional processes used for designing articles of footwear can be expensive and time consuming. When a designer wishes to create an article of footwear with a new material, the designer typically must first obtain the material and then create a physical prototype of the article of footwear. Even when the material is available, creating a physical prototype of the article of footwear may take several weeks because of the number of parts of a typical article of footwear. After the prototype is created, the designer may then wish to modify the design to use different materials, textures or colors. Each modification requires the designer to obtain the necessary materials and construct a prototype article of footwear.

As the design of an article of footwear becomes more complex, the costs and time required to design the article of footwear increase. Athletic footwear, for example, may contain several layered sections that may be made of a variety of materials having assorted colors and textures. A significant portion of the time spent by designers when using conventional design processes to design articles of footwear can involve obtaining materials and creating prototypes of the article of footwear that incorporate the various design elements.

Therefore, there is a need in the art for design systems and methods that allow designers of footwear to obtain design results without going through the time consuming and expensive process of obtaining materials and creating prototypes.

### SUMMARY OF THE INVENTION

One or more of the above-mentioned needs in the art are satisfied by the disclosed virtual sampling systems and methods. Images of articles of footwear are obtained. The images are used to create a simulated three dimensional structure of an article of footwear. Images of design elements, such as materials, textures, etc., and colors used to create articles of footwear are stored in libraries. During the design process, a designer may retrieve images of design elements from the libraries and apply the design elements to the simulated three dimensional structure of the article of footwear to create a virtual design of an article of footwear. One of more images of the design may then be displayed on a display device for viewing by the designer. The designer may then make modifications to the virtual design by selecting different design element images.

In certain embodiments of the invention, the present invention can be partially or wholly implemented with a computer-readable medium, for example, by storing computer-executable instructions or modules, or by utilizing computer-readable data structures.

Of course, the methods and systems of the above-referenced embodiments may also include other additional elements, steps, computer-executable instructions, or computer-readable data structures.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention is illustrated by way of example and not limited in the accompanying figures in which like reference numerals indicate similar elements and in which:

FIG. 1 illustrates a system for creating a virtual representation of an article of footwear, in accordance with an embodiment of the invention;

FIG. 1A illustrates a client-server system for creating a virtual representation of an article of footwear, in accordance with an embodiment of the invention;

FIG. 2 illustrates an image of a gray article of footwear, in accordance with an embodiment of the invention;

FIG. 3 illustrates a virtual representation of an article of footwear designed in accordance with aspects of the invention;

FIG. 4 illustrates an image of an article of footwear that includes a three dimensional wire frame; and

FIG. 5 illustrates a method of creating a virtual representation of an article of footwear, in accordance with an embodiment of the invention.

### DETAILED DESCRIPTION OF THE INVENTION

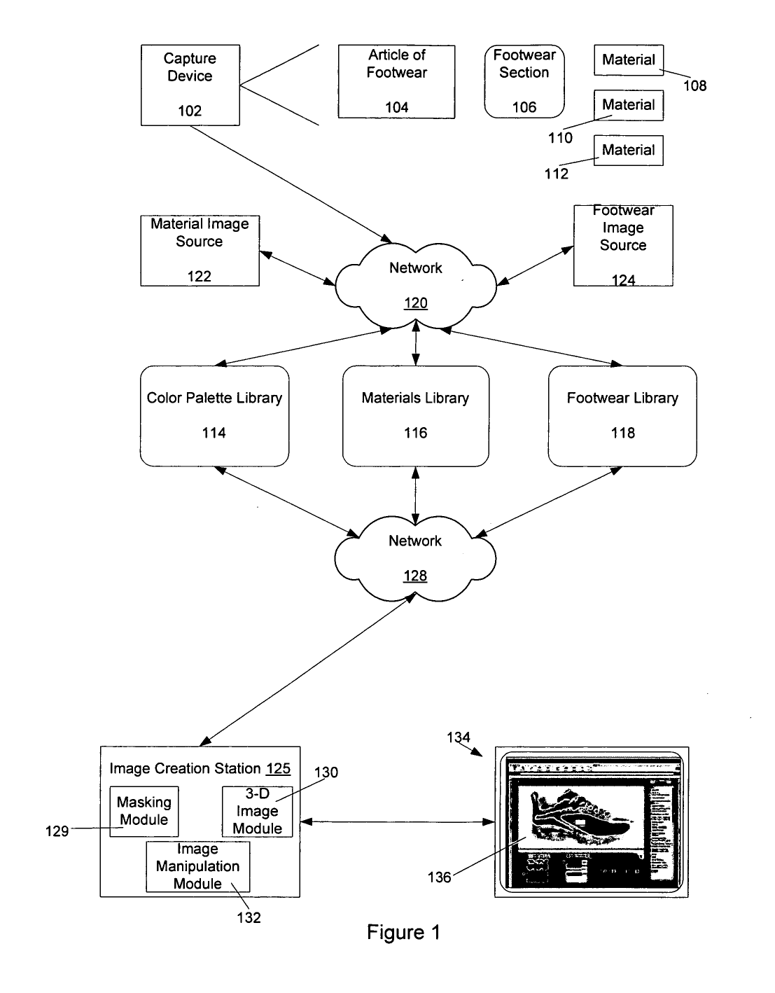

FIG. 1 illustrates a system for creating a virtual representation of an article of footwear in accordance with an embodiment of the invention. A capture device 102, such as a digital camera or scanner may be used to create a digital image of an article of footwear 104. In one embodiment, article of footwear 104 has a monochromatic color scheme, such as college gray. San Fang Chemical Industry Co., Ltd. of Taiwan manufactures a 1.2 millimeter mega synthetic leather material that may be used to create gray footwear.

Capture device 102 may also be used to create digital images of one or more footwear sections 106. Footwear sections may include midsole, upper, outsole and other footwear sections. Digital images of a variety of materials, such as materials 108, 110 and 112 may also be created. Materials 108, 110 and 112 may have textures, colors or other attributes that make them suitable for use with footwear.

Images captured by capture device 102 may be stored in a variety of different libraries, such as materials library 116 and footwear library 118. Image editing software (not shown) may be used to edit captured images before the images are stored in libraries. For example, image editing software may be used to place images in a standard format, size and resolution. Color palette library 114 may contain a collection of color data that corresponds to a collection of colors that may be used when designing footwear. The color data may be stored as hexadecimal data that represents individual colors. In an alternative embodiment, a spectrophometer could be used to capture color data from samples. Materials library 116 may contain a collection of images of materials that may be used to construct footwear and footwear library 118 may contain images of footwear and sections of footwear. One skilled in the art will appreciate that additional or fewer libraries may be used to implement various aspects of the invention. Moreover, additional libraries may contain images of other design elements used in the design of footwear. Libraries 114, 116 and 118 may be located on a server computer device, a design computer device or separate computer devices. One or more of libraries 114, 116 and 118 may also be combined into a single library.

Capture device 102 may be linked to libraries 114, 116 and 118 via a network 128. Network 128 may be implemented (accessed) with a wide area network, such as the Internet, or a local area network. Of course, a computer device (not shown) may be connected to capture device 102 and may receive images and format the images for transport across network 120 to libraries 114, 116 and 118. Libraries 114, 116 and/or 118 may obtain data from sources other than capture device 102. For example, a material image source 122 and a footwear image source 124 may provide images to libraries 114, 116 and 118. In one embodiment of the invention, material image source 122 may be implemented with a vendor that provides materials that are suitable for use in constructing footwear. The vendor may transmit images via network 120 to materials library 116, where the images may be retrieved by a footwear designer. Similarly, footwear image source 124 may be implemented with a vendor that provides various footwear elements.

Libraries 114, 116 and 118 may be connected to or stored on one or more computer devices used to design footwear, such as image creation station 125. In one embodiment, libraries 114, 116 and 118 are connected to image creation station 125 via a network 128. Network 128 may be the same as or form a portion of network 120. Image creation station 125 may include a processor, memory, keyboard, pointing device and other conventional computer device components. Image creation station 125 may also include computer-executable instructions stored on computer-readable media, such as an optical disk, magnetic memory or physical memory, for allowing image creation station 125 to be used to design footwear.

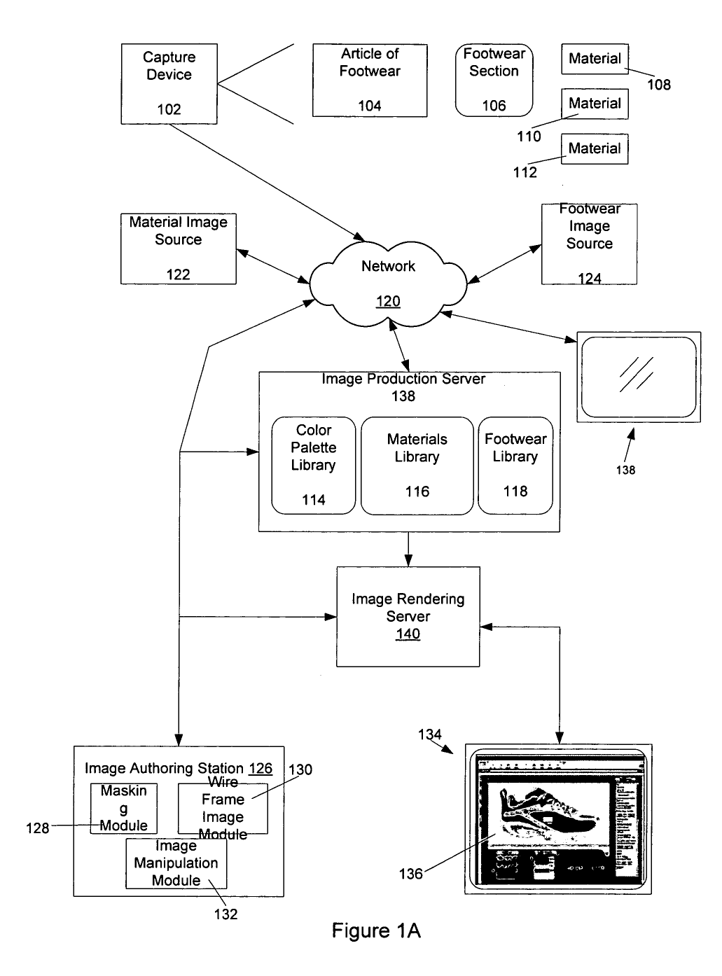

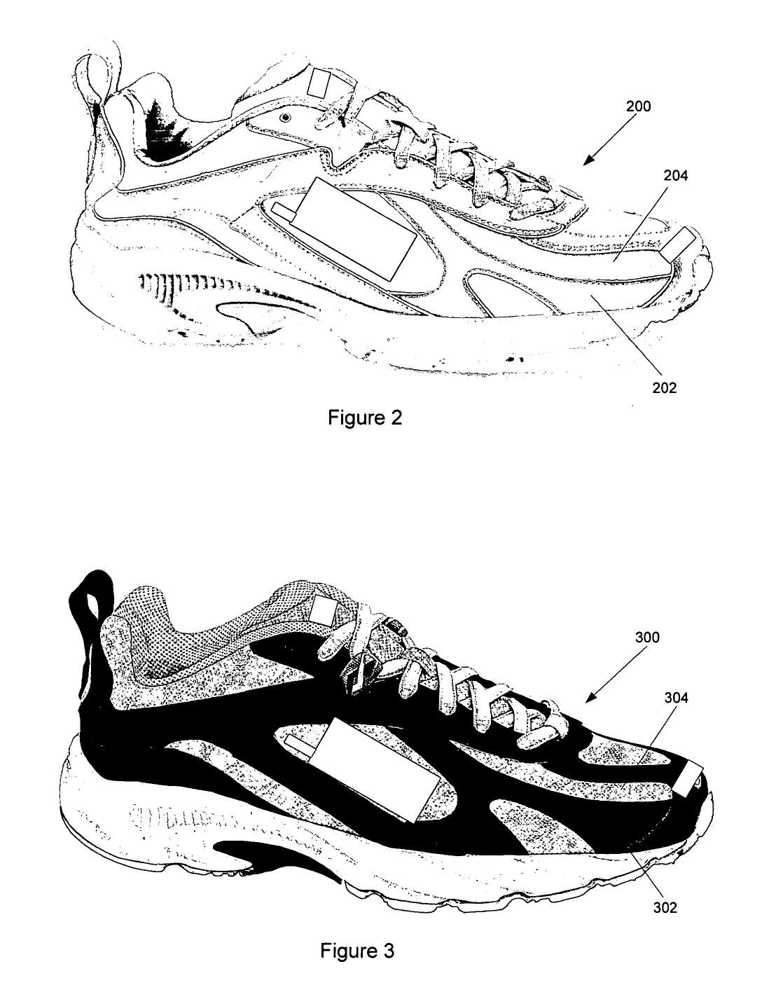

A masking module 129 may be included to define boundaries between the elements of an image of an article of footwear. For example, FIG. 2 illustrates an image 200 of a gray article of footwear. Image 200 may have been generated by capture device 102. Image 200 includes several distinct sections, such as sections 202 and 204. Masking module 129 defines the boundaries between each section, so that in subsequent design steps, colors, materials and other design elements are applied to the correct sections. For example, FIG. 3 illustrates a virtual representation of an article of footwear 300 designed in accordance with aspects of the invention and includes distinct sections 302 and 304 that correspond to sections 202 and 204, respectively. Masking module 129 ensures that a material applied to section 304 is not also applied to section 302 and a color applied to section 302 is not applied to section 304.

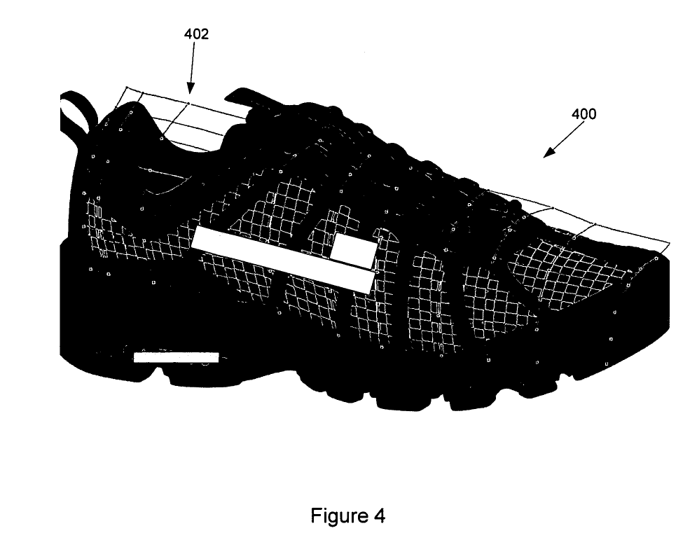

A three dimensional image module 130 may be included to create a simulated three dimensional model of a two dimensional image. For example, FIG. 4 illustrates an image of an article of footwear 400 that includes a three dimensional wire frame 402. Wire frame 402 corresponds to the shape of the article of footwear and may be used when applying colors, materials and other design elements to the article of footwear to ensure that the resulting virtual representation has a three dimensional appearance. Three dimensional image module 130 may create a wire frame that holds image resolution information. As the wire frame is created, three dimensional image module 130 may adjust the image resolution to correspond to the shape of the article of footwear. Adjustments may include stretching and compressing so that as an image of a material or other design element is applied to the simulated three dimensional model, the applied image is distorted to the shape of the wire frame.

An image manipulation module 132 may be included to allow a designer to add images of materials, colors and other design elements to a monochromatic image of an article of footwear to create a virtual representation of an article of footwear. A variety of commercially available software products may be purchased to perform the functions of masking module 129, three dimensional image module 130 and image manipulation module 132. Scene 7, Inc. of Novato, California, for example, sells imaging software that performs these functions.

Image creation station 125 may be connected to a display device 134 that displays a graphical user interface 136 used to design footwear. Graphical user interface 136 may include an image of an article of footwear and user selectable elements that allow a designer to select a footwear design element, such as a color, a texture, a material, or footwear section and apply the design element to the image of the article of footwear.

FIG. 1A illustrates an alternative client-server system for creating a virtual representation of an article of footwear, in accordance with an embodiment of the invention. The elements that are similar to the elements shown in FIG. 1 are labeled the same and will not be described again. Color palette library 114, materials library 116 and footwear library 118 may be stored in or accessed by an image production server 138. Image authoring station 126 may be used to edit images and create new images that are stored in libraries such as palette library 114, materials library 116 and footwear library 118. After a user designs an article of footwear on graphical user interface 136, image authoring station 126 or another computer device may collect the information used to create the article of footwear displayed on the graphical user interface and transmit the information to an image rendering server 140. Image rendering server 140 may then access images and color data of the necessary design elements and render a virtual representation of an article of footwear. For example, a URL string identifying all of the design elements used to create the article of footwear displayed on graphical user interface 136 may be transmitted to image rendering server 140. Image rendering server 140 may then parse the URL string, access the necessary images of design elements from one or more libraries via image production server 138 and render a virtual representation of an article of footwear in the form of a TIFF, JPEG or PNG file.

One skilled in the art will appreciate that aspects of the invention are not limited to specific network configurations. The functionality described above may be implemented with a variety of client and/or server applications. For example, the system shown in FIG. 1A may be modified so that masking module 129, three dimensional image module 130 and image manipulation module 132 are included in image rendering server 140. Other embodiments of the invention may be entirely workstation based.

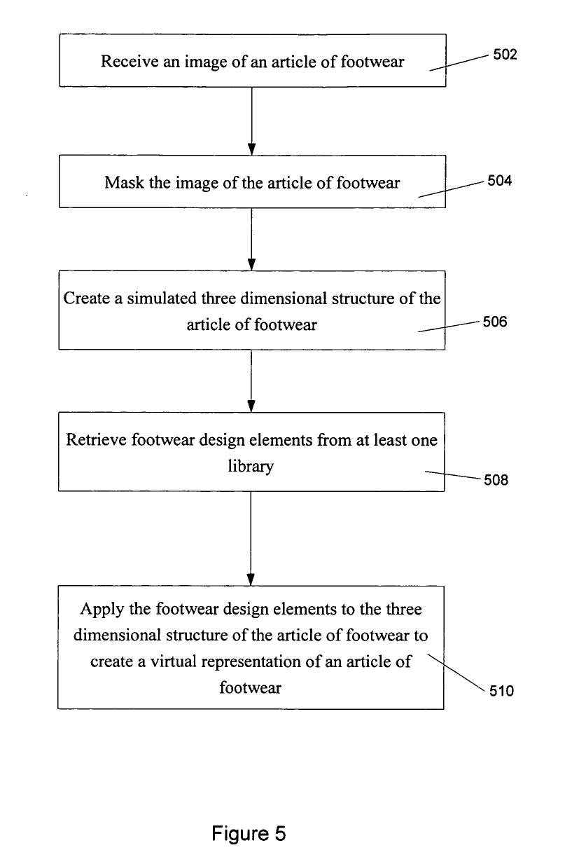

FIG. 5 illustrates a method of creating a virtual representation of an article of footwear, in accordance with an embodiment of the invention. First, in step 502 an image of an article of footwear is received. The image may be received at image authoring station 126 and may be received from capture device 102, footwear library 118 or some other source. Next, in step 504 the image of the article of footwear is masked. As described above, masking an image includes defining boundaries between sections of the image so that footwear design elements may be applied to the appropriate sections. A simulated three-dimensional structure of the article of footwear may then be created in step 506. FIG. 4 shows a wire frame 402 that is used to simulate a three-dimensional structure. Footwear design elements are then retrieved from at least one library in step 508. As mentioned above, footwear design elements may include images of materials and textures, color data or other elements used in the design of footwear. Finally, in step 510 the footwear design elements are applied to the three-dimensional structure of the article of footwear to create a virtual representation of an article of footwear. Applying the footwear design elements to a three-dimensional structure results in an image that resembles an actual article of footwear and provides the designer with a representation of how an actual article of footwear would appear.

One skilled in the art will appreciate that additional steps may be added to the process shown in FIG. 5. For example, after viewing the virtual representation of an article of footwear, the designer may replace and/or add design elements to the virtual representation to create a different design. This process may be repeated numerous times until a suitable design is obtained. Moreover, once a design is obtained, the virtual representation of the article of footwear as well as a listing of the colors, materials, textures and anything other design elements used in the design may be transmitted across a computer network to initiate the creation of a prototype article of footwear.

Aspects of the invention may be used when designing products other than footwear. For example, the design systems and method described above may be used in the design of jackets, hats and other articles of clothing.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A method creating a virtual representation of an article of footwear, the method comprising:
(a) receiving an image of an article of footwear;
(b) creating a simulated three dimensional structure of the article of footwear;
(c) retrieving at least one footwear design element from at least one library; and
(d) applying the at least one footwear design element to the three dimensional structure of the article of footwear to create the virtual representation of an article of footwear.

2. The method of claim 1, wherein the at least one image of an article of footwear comprises an image of a gray article of footwear.

3. The method of claim 1, wherein the at least one image of an article of footwear comprises a monochromatic image

4. The method of claim 1, further including:
(e) masking the image of the article of footwear.

5. The method of claim 1, wherein (e) comprises defining boundaries between elements of the image of the article of footwear.

6. The method of claim 1, wherein (b) comprises creating a simulated three dimensional wire frame.

7. The method of claim 1, wherein the at least one footwear design element comprises color data.

8. The method of claim 1, wherein the at least one footwear design element image comprises an image of a material.

9. The method of claim 1, wherein (d) comprises applying a first image of a material to the three dimensional structure of the article of footwear and then applying color data to the three dimensional structure of the article of footwear to create a virtual representation of an article of footwear that includes aspects of the first image and a color that corresponds to the color data.

10. The method of claim 1, further including combining at least two images of sections of articles of footwear into the image of an article of footwear.

11. A computer-readable medium containing computer-executable instructions for causing a computer device to perform the steps comprising:
(a) receiving an image of an article of footwear;
(b) creating a simulated three dimensional structure of the article of footwear;
(c) retrieving at least one footwear design element from at least one library; and
(d) applying the at least one footwear design element to the simulated three dimensional structure of the article of footwear to create the virtual representation of an article of footwear.

12. The computer-readable medium of claim 11, wherein, the at least one image of an article of footwear comprises a monochromatic image.

13. The computer-readable medium of claim 11, further including computer-executable instructions for causing the computer device to perform the step comprising:
(e) masking the image of the article of footwear.

14. The computer-readable medium of claim 13, wherein (e) comprises defining boundaries between elements of the image of the article of footwear.

15. The computer-readable medium of claim 11, wherein (b) comprises creating a three dimensional wire frame.

16. The computer-readable medium of claim 11, wherein (d) comprises applying a first image of a material to the three dimensional structure of the article of footwear and then applying color data to the three dimensional structure of the article of footwear to create a virtual representation of an article of footwear that includes aspects of the first image and a color that corresponds to the color data.

17. The computer-readable medium of claim 11, further including computer-executable instructions for causing the computer device to perform the step comprising:
combining at least two images of sections of articles of footwear into the image of an article of footwear.

18. A system for designing footwear, the system comprising:
a capture device that captures an image of an article of footwear;
a color palette library that contains color data corresponding to a plurality of colors;
a computer device connected to the capture device and programmed with computer-executable instructions to perform the steps comprising:
(a) receiving from the capture device the image of an article of footwear;
(b) defining boundaries between elements of the image of an article of footwear;
(c) retrieving color data from the color palette library; and
(d) applying the retrieved color data from the color palette library to the image of the article of footwear to create a virtual representation of an article of footwear.

19. The system of claim 18, further including:
a materials library connected to the computer device and containing images of a plurality of materials.

20. The system of claim 18, further including:
a footwear library connected to the computer device and containing images of sections of footwear.
